(19) United States
(12) Patent Application Publication
(10) Pub. No.: US 2011/0273633 A1
(43) Pub. Date: Nov. 10, 2011

(54) PROJECTION SYSTEM AND METHOD FOR ALTERNATELY OUTPUTTING DIFFERENT POLARIZED IMAGE LIGHT SOURCES

(75) Inventor: Chun-Sheng Fan, Hsinchu County (TW)

(73) Assignee: JASPER DISPLAY CORP., Hsinchu (TW)

(21) Appl. No.: 12/950,274

(22) Filed: Nov. 19, 2010

(30) Foreign Application Priority Data
May 7, 2010 (TW) 99114621

(51) Int. Cl. G02F 1/13363; G03B 21/14

(52) U.S. Cl. 349/9; 353/20; 353/121

(57) ABSTRACT

A projection system for alternately outputting different polarized image light sources includes a polarizing beam splitting module, an image display module and a light polarization switch module. The polarizing beam splitting module has at least one polarizing beam splitting element for intermittently receiving a plurality of input light sources according to different time sequences. The image display module has at least one reflective image display panel disposed beside a first side of the polarizing beam splitting element. The light polarization switch module has at least one transmission LCD light valve disposed beside a second side of the polarizing beam splitting element. Therefore, the image light sources with P polarization and the image light sources with S polarization can be intermittently and alternatively projected from the projection lens onto the surface of the object by switching the transmission LCD light valve to ON/OFF state according to different time sequences.

### BACKGROUND OF THE INVENTION

1. Field of the Invention

The instant disclosure relates to a projection system and a method of using the same, and more particularly, to a projection system and a method for alternately outputting different polarized image light sources.

2. Description of Related Art

Due to the advancement in optical and projection display technology, digital projection devices with high pixel resolution are widely employed for briefings, meetings, conferences or trainings. They are also becoming popular for family entertainment. Potential consumers look for lightweight digital projection apparatuses with high image quality and brightness at reasonable prices.

A projector is an apparatus that projects images onto an external screen by optical projection. A projector can be classified into four categories: CRT projector, liquid crystal display (LCD) projector, digital light processing (DLP) projector, and liquid crystal on silicon (LCOS) projector, basing on the type of light valve onboard. Moreover, the LCD projector is a transmission type projector because the onboard LCD panel is pervious to light. The LCOS and the DLP projectors are reflection type projectors because their image formation bases on light reflection principles.

The LCOS projector and the LCD projector are based on similar principles. However, unlike the LCD projector in which the light source is mounted behind the LCD panel

Traditionally, to generate 3D images, two projectors are required in a special arrangement to provide separate light sources of S and P polarizations. However, the conventional setup not only the costs more due to the concurrent use of two projectors but also occupies a large space.

### SUMMARY OF THE INVENTION

One particular aspect of the instant disclosure is to provide a projection system for alternately outputting different polarized image light sources without using two projectors at the same time.

Another particular aspect of the instant disclosure is to provide a method for alternately outputting different polarized image light sources without using two projectors at the same time.

To achieve the above-mentioned aspects, the instant disclosure provides a projection system for alternately outputting different polarized image light sources, including: a polarizing beam splitting module, an image display module and a light polarization switch module. The polarizing beam splitting module has at least one polarizing beam splitting element

To achieve the above-mentioned aspects, the instant disclosure provides a method for alternately outputting different polarized image light sources, including the steps of: intermittently generating a plurality of first light sources with P polarization to sequentially pass through at least one polarizing beam splitting element according to different time sequences; sequentially reflecting and transforming the first light sources with P polarization into a plurality of second light sources with S polarization via the at least one reflective image display panel, wherein the at least one reflective image display panel is disposed beside a first side of the at least one polarizing beam splitting element; sequentially reflecting and transmitting the second light sources with S polarization to at least one transmission LCD light valve via the at least one polarizing beam splitting element, wherein the at least one transmission LCD light valve is disposed beside a second side of the at least one polarizing beam splitting element; and sequentially transmitting the second light sources with S polarization to pass through the at least one transmission LCD light valve to intermittently and alternatively output image light sources with P polarization and image light sources with S polarization.

To achieve the above-mentioned aspects, the instant disclosure provides a method for alternately outputting different polarized image light sources, including the steps of: intermittently transmitting a plurality of first light sources with S polarization to at least one

To achieve the above-mentioned aspects, the instant disclosure provides a projection system for alternately outputting different polarized image light sources, including: a prism module, an image display module and a light polarization switch module. The prism module has at least one total internal reflection prism for intermittently receiving a plurality of input light sources according to different time sequences. The image display module has at least one reflective image display panel disposed beside a first side of the at least one total internal reflection prism. The light polarization switch module has at least one transmission LCD light valve disposed beside a second side of the at least one total internal reflection prism.

Therefore, the image light sources with P polarization and the image light sources with S polarization can be intermittently and alternatively projected from the projection lens onto the surface of the object by switching the transmission LCD light valve to ON/OFF state

In order to further understand the techniques, means and effects the instant disclosure takes for achieving the prescribed objectives, the following detailed descriptions and appended drawings are hereby referred, such that, through which, the purposes, features and aspects of the instant disclosure can be thoroughly and concretely appreciated; however, the appended drawings are provided solely for reference and illustration, without any intention that they be used for limiting the instant disclosure.

### BRIEF DESCRIPTION OF THE DRAWINGS

FIG. 1A is a schematic view of the projection system for alternately outputting different polarized image light sources according to the first embodiment of the instant disclosure;

FIG. 1B is a lateral, schematic view of the transmission LCD light valve the projection system according to the first embodiment of the instant disclosure;

FIG. 1C is a flowchart of the method for alternately outputting different polarized image light sources according to the first embodiment of the instant disclosure;

FIG. 2A is a schematic view of the projection system for alternately outputting different polarized image light sources according to the second embodiment of the instant disclosure;

FIG. 2B is a flowchart of the method for alternately outputting different polarized image light sources according to the second embodiment of the instant disclosure;

FIG. 3 is a schematic view of the projection system for alternately outputting different polarized image light sources according to the third embodiment of the instant disclosure; and

FIG. 4 is a partial, schematic view of the projection system for alternately outputting different polarized image light sources according to the fourth embodiment of the instant disclosure.

### DETAILED DESCRIPTION OF THE PREFERRED EMBODIMENTS

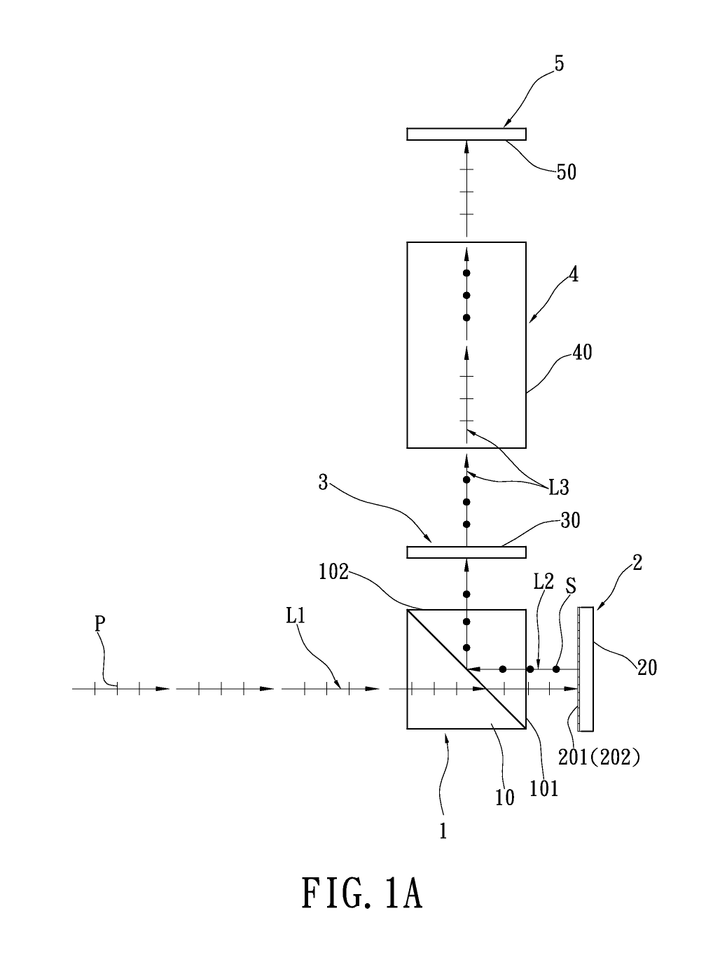

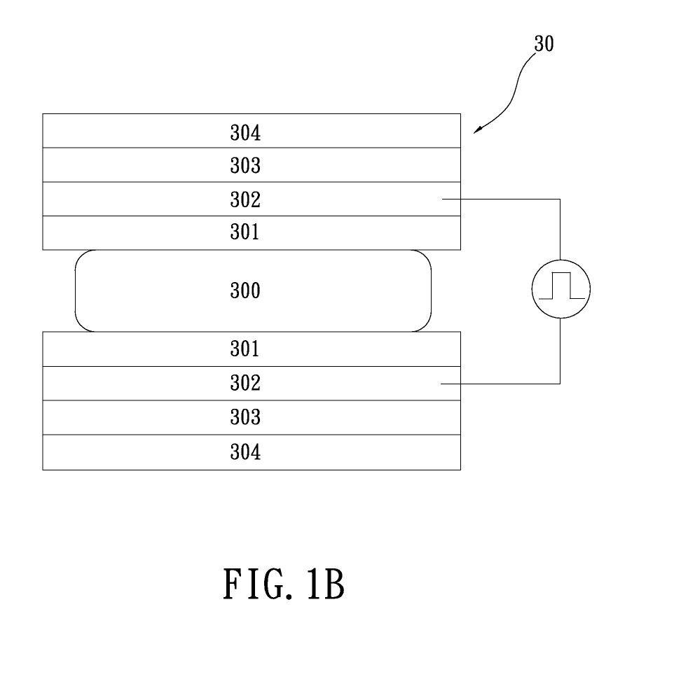

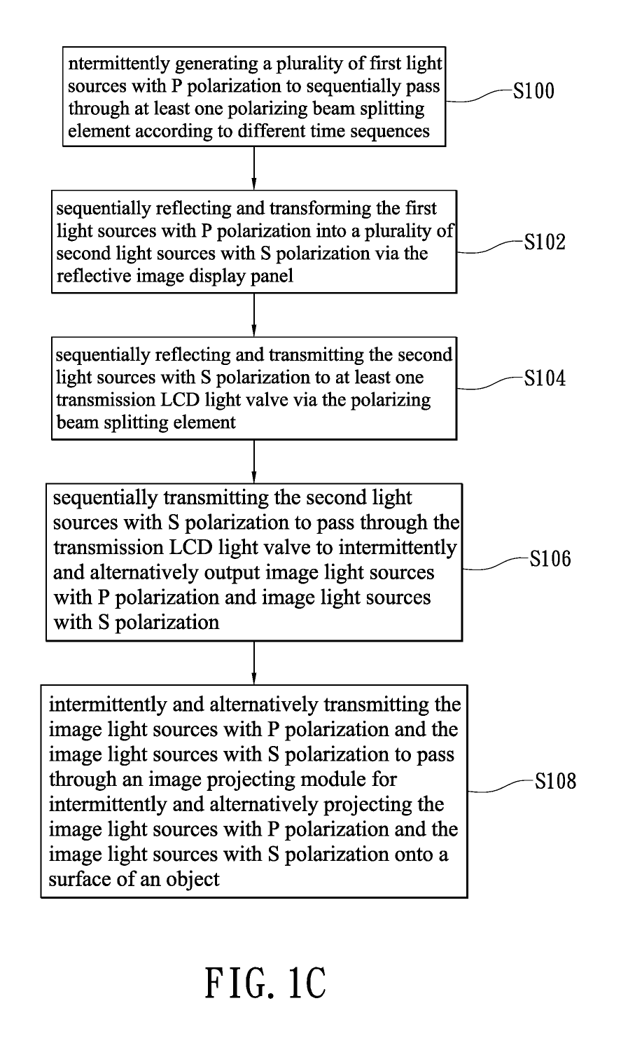

Referring to FIGS. 1A and 1B, the first embodiment of the instant disclosure provides a projection system for alternately outputting different polarized image light sources, including: a polarizing beam splitting module 1, an image display module 2, a light polarization switch module 3 and an image projecting module 4.

The polarizing beam splitting module 1 has at least one polarizing beam splitting element such as polarizing beam splitter (PBS) for intermittently receiving a plurality of input light sources according to different time sequences. The image display module 2 has at least one reflective image display panel 20 disposed beside (or corresponding to) a first side 101 of the polarizing beam splitting element 10. The light polarization switch module 3 has at least one transmission LCD (Liquid Crystal Display) light valve 30 disposed beside a second side 102 of the polarizing beam splitting element 10, and the first side 101 is adjacent to the second side 102. The image projecting module 4 has at least one projection lens 40 disposed beside one side of the

Referring to FIG. 1B, the transmission LCD light valve 30 has a liquid crystal layer 300, two liquid-crystal alignment films 301 respectively formed on a top surface and a bottom surface of the liquid crystal layer 300, two indium oxide tin (ITO) layers 302 formed on two surfaces of the two liquid-crystal alignment films 301, two glass layers 303 respectively formed on two surfaces of the two indium oxide tin layers 302, and two anti-reflection films 304 respectively formed on two surfaces of the two glass layers 303. However, the above-mention description of the transmission LCD light valve 30 is just an example and does not used to limit the instant disclosure.

For example, referring to FIG. 1A, each input light source is defined as a first light source L1 with P polarization (shown as “−” and letter “P” in FIG. 1A), each first light source L1 with P polarization may be a continuous RGB (Red, Green and Blue) source, and the reflective image display panel 20 may be a reflective LCOS panel that has a plurality of reflective mirrors 201.

Hence, the first light sources L1 with P polarization sequentially can pass through the polarizing beam splitting element 10 and are sequentially transformed into a plurality of second light sources L2 with S polarization (shown as “” and letter “S” in FIG. 1A) via the reflective image display panel 20. Next, the second light sources L2 with S polarization can be sequentially transmitted to the transmission LCD light valve 30 via the polarizing beam splitting element 10 and sequentially pass through the transmission LCD light valve 30 to intermittently

Referring to FIGS. 1A and 1C, the first embodiment of the instant disclosure provides a method for alternately outputting different polarized image light sources, comprising the steps of:

The step S100 is that: intermittently generating a plurality of first light sources L1 with P polarization (shown as “−” and letter “P” in FIG. 1A) to sequentially pass through at least one polarizing beam splitting element 10 according to different time sequences.

The step S102 is that: sequentially reflecting and transforming the first light sources L1 with P polarization into a plurality of second light sources L2 with S polarization (shown as “” and letter “S” in FIG. 1A) via the reflective image display panel 20; wherein the reflective image display panel 20 is disposed beside a first side 101 of the polarizing beam splitting element 10.

The step S104 is that: sequentially reflecting and transmitting the second light sources L2 with S polarization to at least one transmission LCD light valve 30 via the polarizing beam splitting element 10; wherein the transmission LCD light valve 30 is disposed beside a second side 102 of the polarizing beam splitting element 10.

The step S106 is that: sequentially transmitting the second light sources L2 with S polarization to pass through the transmission LCD light valve 30 to intermittently and alternatively output image light sources L3 with P polarization and image light sources L3 with S polarization.

The step S108 is that: intermittently and alternatively transmitting the image light sources L3 with P polarization and the image light sources L3 with S polarization to pass through an image projecting module 4 for intermittently and alternatively projecting the image light sources L3 with P polarization and the image light sources L3 with S polarization onto a surface 50 of an object 5; wherein the image projecting module 4 has at least one projection lens 40 disposed beside one side of the transmission LCD light valve 30, thus the transmission LCD light valve 30 is disposed between the polarizing beam splitting element 10 and the projection lens 40.

Hence, the image light sources L3 with P polarization and the image light sources L3 with S polarization can be intermittently and alternatively projected from the projection lens 40 onto the surface 50 of the object 5 by switching the transmission LCD light valve 30 to ON/OFF state according to different time sequences, thus a viewer can receive 3D images from the surface 50 such as a screen by wearing a 3D glasses, which can receive S polarized light and P polarized light simultaneously (for example, a left lens of the glasses can receive S polarized light while a right lens receive P polarized light). Therefore, the generation of 3D images can be achieved by using only a single projector unit in the first embodiment.

Of course, in the first embodiment, each first light source L1 (each continuous RGB source) with P polarization can be replaced by a continuous white source and the reflective image display panel 20 (the reflective LCOS panel with the reflective mirrors 201) can be

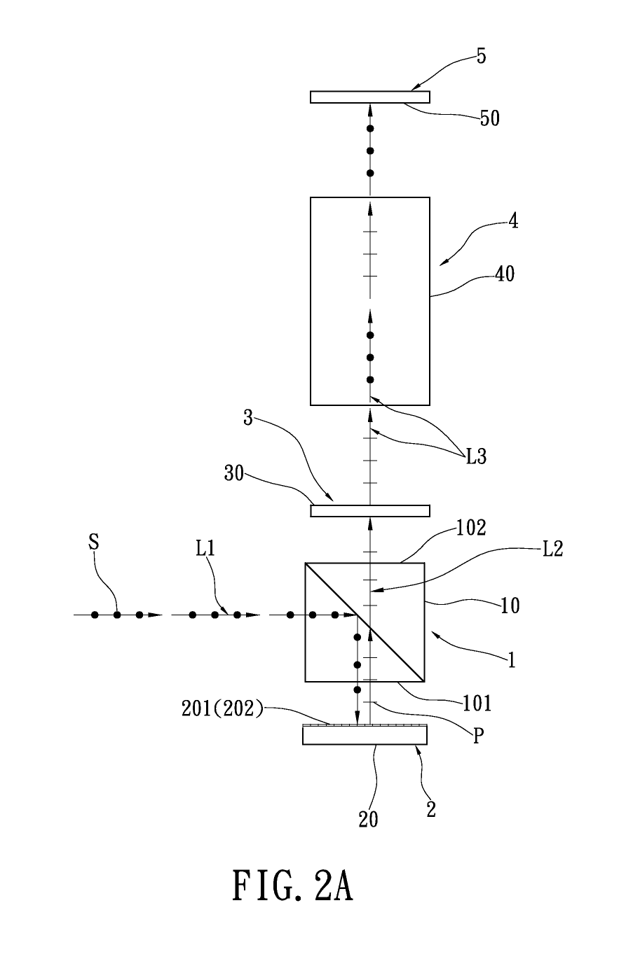

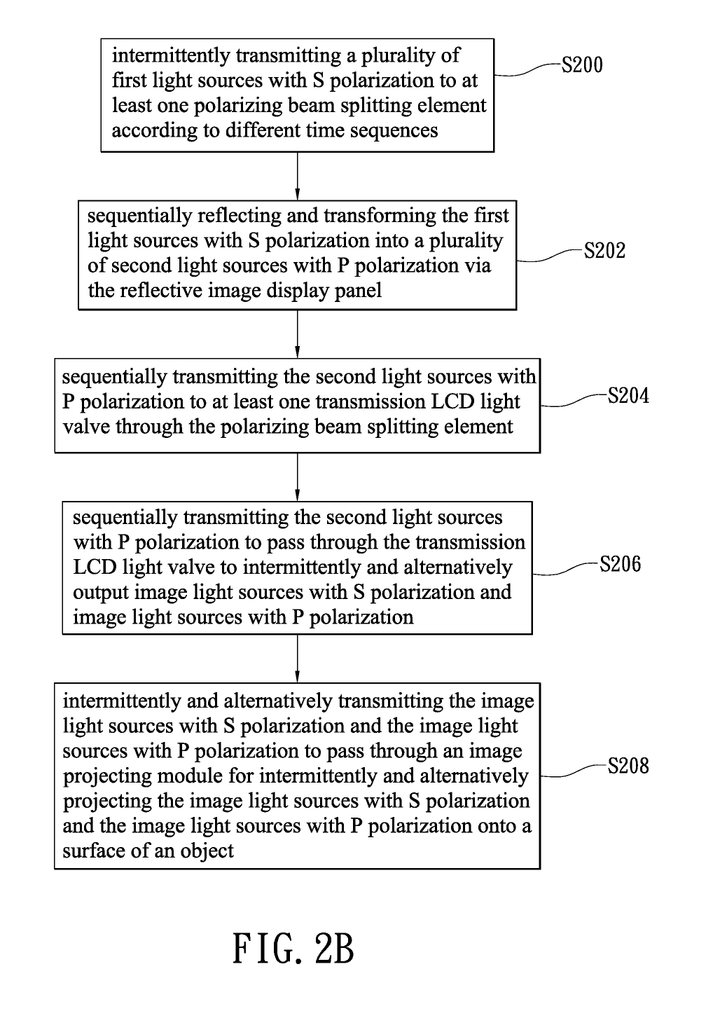

Referring to FIG. 2A, the second embodiment of the instant disclosure provides a projection system for alternately outputting different polarized image light sources, including: a polarizing beam splitting module 1, an image display module 2, a light polarization switch module 3 and an image projecting module 4.

The polarizing beam splitting module 1 has at least one polarizing beam splitting element such as polarizing beam splitter (PBS) for intermittently receiving a plurality of input light sources according to different time sequences. The image display module 2 has at least one reflective image display panel 20 disposed beside a first side 101 of the polarizing beam splitting element 10. The light polarization switch module 3 has at least one transmission LCD (Liquid Crystal Display) light valve 30 disposed beside a second side 102 of the polarizing beam splitting element 10, and the first side 101 and the second side 102 are two opposite sides. The image projecting module 4 has at least one projection lens 40 disposed beside one side of the transmission LCD light valve 30, thus the transmission LCD light valve 30 is disposed between the polarizing beam splitting element 10 and the projection lens 40.

For example, referring to FIG. 2A, each input light source is defined as a first light source L1 with S polarization (shown as “” and letter “S” in FIG. 2A), each first light source L1 with S polarization may be a continuous RGB (Red, Green and Blue) source, and the reflective

Hence, the first light sources L1 with S polarization are sequentially transformed into a plurality of second light sources L2 with P polarization (shown as “−” and letter “P” in FIG. 2A) via the polarizing beam splitting element 10 and the reflective image display panel 20, the second light sources L2 with P polarization are sequentially pass through the polarizing beam splitting element 10 and the transmission LCD light valve 30 to intermittently and alternatively output image light source L3 with S polarization and image light source L3 with P polarization. In other words, the image light sources L3 with S polarization and the image light sources L3 with P polarization can intermittently and alternatively output from the transmission LCD light valve 30 by switching the transmission LCD light valve 30 to ON/OFF state according to different time sequences.

Referring to FIGS. 2A and 2B, the second embodiment of the instant disclosure provides a method for alternately outputting different polarized image light sources, comprising the steps of:

The step S200 is that: intermittently transmitting a plurality of first light sources L1 with S polarization (shown as “” and letter “S” in FIG. 2A) to at least one polarizing beam splitting element 10 according to different time sequences.

The step S202 is that: sequentially reflecting and transforming the first light sources L1 with S polarization into a plurality of second light sources L2 with P polarization (shown as “−” and letter “P” in FIG. 2A) via the reflective image display panel 20; wherein the

The step S204 is that: sequentially transmitting the second light sources L2 with P polarization to at least one transmission LCD light valve 30 through the polarizing beam splitting element 10; wherein the transmission LCD light valve 30 is disposed beside a second side 102 of the polarizing beam splitting element 10.

The step S206 is that: sequentially transmitting the second light sources L2 with P polarization to pass through the transmission LCD light valve 30 to intermittently and alternatively output image light sources L3 with S polarization and image light sources L3 with P polarization.

The step S208 is that: intermittently and alternatively transmitting the image light sources L3 with S polarization and the image light sources L3 with P polarization to pass through an image projecting module 4 for intermittently and alternatively projecting the image light sources L3 with S polarization and the image light sources L3 with P polarization onto a surface 50 of an object 5; wherein the image projecting module 4 has at least one projection lens 40 disposed beside one side of the transmission LCD light valve 30, thus the transmission LCD light valve 30 is disposed between the polarizing beam splitting element 10 and the projection lens 40.

Hence, the image light sources L3 with S polarization and the image light sources L3 with P polarization can be intermittently and alternatively projected from the projection lens 40 onto the surface 50 of the object 5 by switching the transmission LCD light valve 30 to ON/OFF state according to different time sequences, thus a viewer can receive 3D images from the surface 50 such as a screen by wearing a 3D glasses, which can receive S polarized light and

Of course, in the second embodiment, each first light source L1 (each continuous RGB source) with P polarization can be replaced by a continuous white source and the reflective image display panel 20 (the reflective LCOS panel with the reflective mirrors 201) can be replaced by a reflective LCOS panel that has a plurality of RGB filters 202, according to different requirements. In other words, either the continuous RGB sources mated with the reflective LCOS panel having the reflective mirrors 201 or the continuous white sources mated with the reflective LCOS panel having the RGB filters 202 can be applied to the instant disclosure.

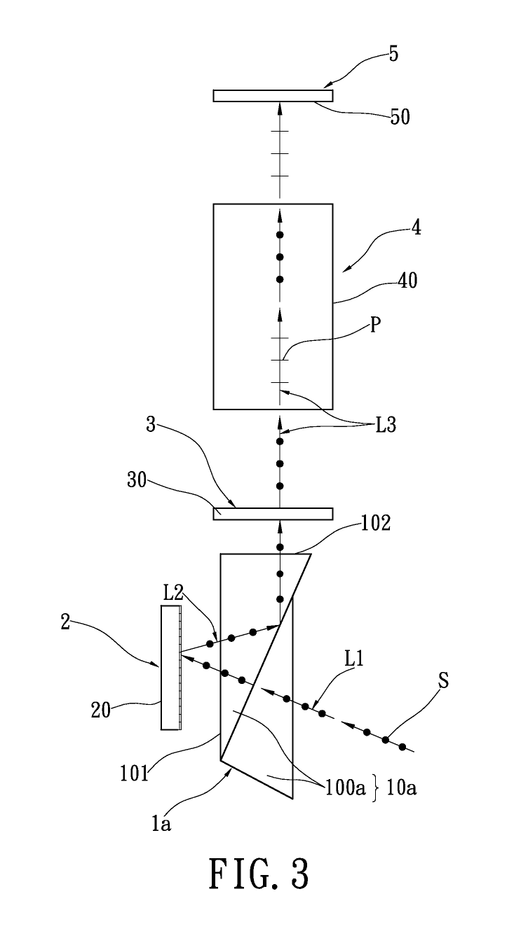

Referring to FIG. 3, the third embodiment of the instant disclosure provides a projection system for alternately outputting different polarized image light sources, including: a prism module 1a, an image display module 2, a light polarization switch module 3 and an image projecting module 4. In addition, the prism module 1a has at least one total internal reflection prism 10a for intermittently receiving a plurality of input light sources according to different time sequences, and the total internal reflection prism 10a can be composed of many prisms 100a. The image display module 2 has at least one reflective image display panel 20 disposed beside a first side 101 of the total internal reflection prism 10a, and the reflective image display panel 20 may be a DLP panel. The light polarization switch module 3 has at least one transmission LCD light valve 30 disposed beside a second side 102 of the total internal reflection prism 10, and the first side 101 is adjacent to the second side 102. The image projecting module

Hence, the image light sources L3 with P polarization and the image light sources L3 with S polarization can be intermittently and alternatively projected from the projection lens 40 onto the surface 50 of the object 5 by switching the transmission LCD light valve 30 to ON/OFF state according to different time sequences, thus a viewer can receive 3D images from the surface 50 such as a screen by wearing a 3D glasses, which can receive S polarized light and P polarized light simultaneously (for example, a left lens of the glasses can receive S polarized light while a right lens receive P polarized light). Therefore, the generation of 3D images can be achieved by using only a single projector unit in the third embodiment.

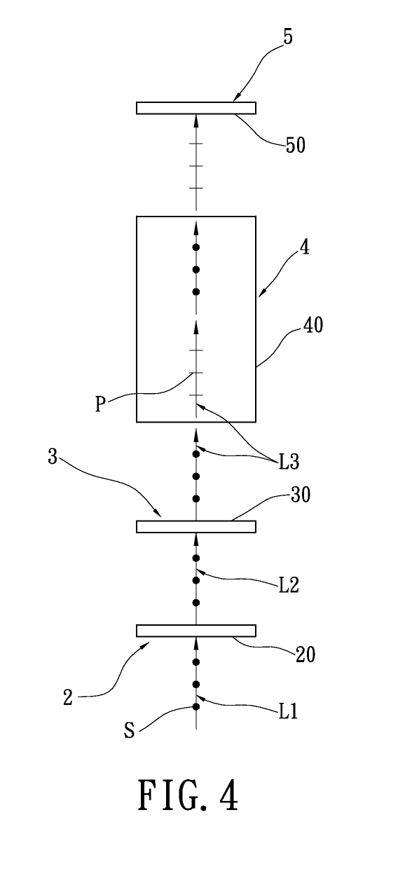

Referring to FIG. 4, the fourth embodiment of the instant disclosure provides a projection system for alternately outputting different polarized image light sources, including: a polarizing beam splitting module (not shown), an image display module 2, a light polarization switch module 3 and an image projecting module 4. In addition, the image display module 2 has at least one reflective image display panel 20 that may be a transmission LCD panel for generate image light sources with S polarization (as shown in FIG. 4) or P polarization. The difference between the fourth embodiment and the first embodiment is that: the reflective LCOS panel of the first embodiment can be replaced by the transmission LCD panel of the fourth embodiment.

Hence, the image light sources L3 with P polarization and the image light sources L3 with S polarization can be intermittently and alternatively projected from the projection lens 40 onto the surface 50 of the object 5 by switching the transmission LCD light valve 30 to

Of course, the polarizing beam splitting module (not shown) of the fourth embodiment can be omitted. In other words, either the projection system composed of the polarizing beam splitting module 1 (as shown in FIG. 1A), the image display module 2, the light polarization switch module 3 and the image projecting module 4 or composed of the image display module 2, the light polarization switch module 3 and the image projecting module 4 (as shown in FIG. 1A) can alternately output different polarized image light sources.

The above-mentioned descriptions merely represent solely the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. A projection system for alternately outputting different polarized image light sources, comprising:
a polarizing beam splitting module having at least one polarizing beam splitting element for intermittently receiving a plurality of input light sources according to different time sequences;
an image display module having at least one reflective image display panel disposed beside a first side of the at least one polarizing beam splitting element; and
a light polarization switch module having at least one transmission LCD light valve disposed beside a second side of the at least one polarizing beam splitting element.

2. The projection system as claimed in claim 1, further comprising an image projecting module having at least one projection lens disposed beside one side of the at least one transmission LCD light valve, thus the at least one transmission LCD light valve is disposed between the at least one polarizing beam splitting element and the at least one projection lens.

3. The projection system as claimed in claim 1, wherein each input light source is a first light source with P polarization, the first light sources with P polarization sequentially pass through the at least one polarizing beam splitting element and are sequentially transformed into a plurality of second light sources with S polarization via the at least one reflective image display panel, the second light sources with S polarization are sequentially transmitted to the at least one transmission LCD light valve via the at least one polarizing beam splitting element and sequentially pass through the at least

4. The projection system as claimed in claim 3, wherein each first light source with P polarization is a continuous RGB source, and the at least one reflective image display panel is a reflective LCOS panel that has a plurality of reflective mirrors.

5. The projection system as claimed in claim 3, wherein each first light source with P polarization is a continuous white source, and the at least one reflective image display panel is a reflective LCOS panel that has a plurality of RGB filters.

6. The projection system as claimed in claim 1, wherein each input light source is a first light source with S polarization, the first light sources with S polarization are sequentially transformed into a plurality of second light sources with P polarization via the at least one polarizing beam splitting element and the at least one reflective image display panel, the second light sources with P polarization are sequentially pass through the at least one polarizing beam splitting element and the at least one transmission LCD light valve to intermittently and alternatively output image light source with S polarization and image light source with P polarization.

7. The projection system as claimed in claim 6, wherein each first light source with P polarization is a continuous RGB source, and the at least one reflective image display panel is a reflective LCOS panel that has a plurality of reflective mirrors.

8. The projection system as claimed in claim 6, wherein each first light source with P polarization is a continuous white source, and the at least one reflective image display panel is a reflective LCOS panel that has a plurality of RGB filters.

9. The projection system as claimed in claim 1, wherein the at least one transmission LCD light valve has a liquid crystal layer, two liquid-crystal alignment films respectively formed on a top surface and a bottom surface of the liquid crystal layer, two indium oxide tin layers formed on two surfaces of the two liquid-crystal alignment films, two glass layers respectively formed on two surfaces of the two indium oxide tin layers, and two anti-reflection films respectively formed on two surfaces of the two glass layers.

10. A method for alternately outputting different polarized image light sources, comprising the steps of:
intermittently generating a plurality of first light sources with P polarization to sequentially pass through at least one polarizing beam splitting element according to different time sequences;
sequentially reflecting and transforming the first light sources with P polarization into a plurality of second light sources with S polarization via the at least one reflective image display panel, wherein the at least one reflective image display panel is disposed beside a first side of the at least one polarizing beam splitting element;
sequentially reflecting and transmitting the second light sources with S polarization to at least one transmission LCD light valve via the at least one polarizing beam splitting element, wherein the at least one transmission LCD light valve is disposed beside a second side of the at least one polarizing beam splitting element; and
sequentially transmitting the second light sources with S polarization to pass through the at least one transmission LCD light valve to intermittently and alternatively output image light sources with P polarization and image light sources with S polarization.

11. The method as claimed in claim 10, further comprising intermittently and alternatively transmitting the image light sources with P polarization and the image light sources with S polarization to pass through an image projecting module for intermittently and alternatively projecting the image light sources with P polarization and the image light sources with S polarization onto a surface of an object, wherein the image projecting module has at least one projection lens disposed beside one side of the at least one transmission LCD light valve, thus the at least one transmission LCD light valve is disposed between the at least one polarizing beam splitting element and the at least one projection lens.

12. The method as claimed in claim 10, wherein each first light source with P polarization is a continuous RGB source, and the at least one reflective image display panel is a reflective LCOS panel that has a plurality of reflective mirrors.

13. The method as claimed in claim 10, wherein each first light source with P polarization is a continuous white source, and the at least one reflective image display panel is a reflective LCOS panel that has a plurality of RGB filters.

14. The method as claimed in claim 10, wherein the at least one transmission LCD light valve has a liquid crystal layer, two liquid-crystal alignment films respectively formed on a top surface and a bottom surface of the liquid crystal layer, two indium oxide tin layers formed on two surfaces of the two liquid-crystal alignment films, two glass

15. A method for alternately outputting different polarized image light sources, comprising the steps of:
intermittently transmitting a plurality of first light sources with S polarization to at least one polarizing beam splitting element according to different time sequences;
sequentially reflecting and transforming the first light sources with S polarization into a plurality of second light sources with P polarization via the at least one reflective image display panel, wherein the at least one reflective image display panel is disposed beside a first side of the at least one polarizing beam splitting element;
sequentially transmitting the second light sources with P polarization to at least one transmission LCD light valve through the at least one polarizing beam splitting element, wherein the at least one transmission LCD light valve is disposed beside a second side of the at least one polarizing beam splitting element; and
sequentially transmitting the second light sources with P polarization to pass through the at least one transmission LCD light valve to intermittently and alternatively output image light sources with S polarization and image light sources with P polarization.

16. The method as claimed in claim 15, further comprising intermittently and alternatively transmitting the image light sources with S polarization and the image light sources with P polarization to pass through an image projecting module for intermittently and alternatively projecting the image light sources with S polarization and the image light sources with P polarization onto a surface of an object, wherein the image projecting
ed in claim 15, wherein each first light source with P polarization is a continuous RGB source, and the at least one reflective image display panel is a reflective LCOS panel that has a plurality of reflective mirrors.

18. The method as claimed in claim 15, wherein each first light source with P polarization is a continuous white source, and the at least one reflective image display panel is a reflective LCOS panel that has a plurality of RGB filters.

19. The method as claimed in claim 15, wherein the at least one transmission LCD light valve has a liquid crystal layer, two liquid-crystal alignment films respectively formed on a top surface and a bottom surface of the liquid crystal layer, two indium oxide tin layers formed on two surfaces of the two liquid-crystal alignment films, two glass layers respectively formed on two surfaces of the two indium oxide tin layers, and two anti-reflection films respectively formed on two surfaces of the two glass layers.

20. A projection system for alternately outputting different polarized image light sources, comprising:
a prism module having at least one total internal reflection prism for intermittently receiving a plurality of input light sources according to different time sequences;
an image display module having at least one reflective image display panel disposed beside a first side of the at least one total internal reflection prism; and
a light polarization switch module having at least one transmission LCD light valve disposed beside a second side of the at least one total internal reflection prism.

21. A projection system for alternately outputting different polarized image light sources, comprising:
a polarizing beam splitting module having at least one polarizing beam splitting element for intermittently receiving a plurality of input light sources according to different time sequences;
an image display module having at least one transmission LCD panel disposed beside a first side of the at least one polarizing beam splitting element; and
a light polarization switch module having at least one transmission LCD light valve disposed beside a second side of the at least one polarizing beam splitting element.
